(19) United States
(12) Patent Application Publication
(10) Pub. No.: US 2011/0057635 A1
(43) Pub. Date: Mar. 10, 2011

(54) Switching regulator

(75) Inventor: Shinichiro Ishikawa, Kanagawa (JP)

(73) Assignee: Renesas Electronics Corporation, Kanagawa (JP)

(21) Appl. No.: 12/923,234

(22) Filed: Sep. 10, 2010

(30) Foreign Application Priority Data
Sep. 10, 2009 (JP) 2009-209610

(51) Int. Cl. G05F 1/10; G05F 1/625

(52) U.S. Cl. 323/282

(57) ABSTRACT

A switching regulator includes a switch circuit that delivers a power from a power supply side to an output side, and a smoothing circuit that smoothes the voltage on the output side. The switching regulator also includes an on/off control circuit that controls the on/off of the switch circuit, as the duty ratio is changed depending on the value of the output voltage, so that the output voltage will be equal to a preset voltage. The switching regulator further includes an on-resistance control circuit that exercises control to increase the on-resistance of the switch circuit when the output voltage is lower by not less than a predetermined voltage than the preset voltage.

### REFERENCE TO RELATED APPLICATION

This application is based upon and claims the benefit of the priority of Japanese patent application No. 2009-209610, filed on Sep. 10, 2009, the disclosure of which is incorporated herein in its entirety by reference thereto.

### TECHNICAL FIELD

This invention relates to a switching regulator. More particularly, it relates to a switching regulator having a soft start function of preventing an excessive rush current from flowing on startup of a circuit operation.

### BACKGROUND

There is extensively used, as a power supply for an electronic circuit, a switching regulator that transforms, based on switching of switching elements, an input power supply into an output power supply which is of a power supply system different from that of the input power supply. In such switching regulator, a soft start circuit is used to prohibit the rush current or overshoot of the output voltage caused by rapid rise of the output power supply.

FIGS. 7A and 7B respectively depict a circuit diagram and a timing chart of a switching regulator having a conventional soft-start circuit as disclosed in Patent Document 1. Referring to FIG. 7A, showing this conventional switching regulator, an error voltage between a voltage divided from an output voltage V3 of a switching regulator 30 by a voltage divider circuit 32 and a reference voltage Vref generated by a voltage generator 331 is amplified, during the normal operation, by an OP amp 333 of a comparison signal generator 33. The voltage of a signal corresponding to an amplified version of the error voltage and the voltage of a triangular wave generated by a reference waveform generator 341 are compared to each other by an OP amp 342 to generate a PWM signal. This PWM signal controls the on/off of a MOSFET switch 4 so that the output voltage V3 will be equal to a constant voltage.

Referring to FIG. 7A, in soft starting, a resistor R3 and a capacitor C3 exercise control so that the reference voltage Vref will rise slowly. Thus, even though the output V3 is a low voltage, the duty ratio of the PWM signal is suppressed to prevent the rush current from flowing. FIG. 7B shows that, in the soft starting, the pulse width of the output voltage V2, as a PWM signal, is decreased. Further, in Patent Document 1, there is provided a function restoration circuit 39 that allows the soft-start function to be in play even if the input voltage V1 has been lowered by some reason or other.

FIG. 8A depicts a block diagram showing another switching regulator having another conventional soft-start function as described in Patent Document 2. FIG. 8B depicts a timing diagram for illustrating the soft-start function of the switching regulator shown in FIG. 8A. In the switching regulator shown in Patent Document 1, the reference voltage in soft starting is generated by a resistor R3 and a capacitor C3, whereas, in the switching regulator shown in FIGS. 8A and 8B, the reference voltage is generated by a counter 6 and a D/A 7. It is stated that, in FIG. 8B, (b) D/A convert signal Vc′, it is stated that the D/A convert voltage is progressively elevated to progressively increase the duty ratio. Meanwhile, it is stated in Patent Document 2 that the soft start circuit, making use of the CR time constant circuit, may not be built with ease on an IC chip, because of the large size capacitor used in the time constant circuit, whereas the soft start circuit, making use of a D/A, lends itself to integration on the IC chip.

FIG. 9A depicts a block diagram showing a switching regulator having a further different soft starting function as described in Patent Document 3. FIG. 9B depicts a timing chart for the switching regulator. A limiter 20 shown in FIG. 9A clamps the output voltage of an OP amp OP1 at a limit voltage Vlim until a voltage Vfb divided from an output voltage Vout by voltage dividing resistors R1, R2 reaches a preset limit voltage Vlim_ref. Hence, the duty ratio of a transistor Q1, a switch shown in (d) of FIG. 9B, is set at a constant value during the limit period shown in (b) of FIG. 9B.

### [Patent Document 1]

JP Patent Kokai Publication No. JP2004-173481A, which corresponds to US Patent Application Publication No. US2004/0085052A1.

### [Patent Document 2]

WO2006/068012 pamphlet, which corresponds to US Patent Application Publication No. US2009/0273324A1.

### [Patent Document 3]

JP Patent Kokai Publication No. JP2007-028732A

### SUMMARY

The entire disclosures of the above-mentioned Patent Documents are incorporated herein by reference thereto.

The following analysis is given by the present invention. If soft start is to be implemented by the CR time constant circuit, as in Patent Document 1, the capacitor has to be mounted outside an IC chip. It is because the capacitor for soft start is larger in size and is difficult to mount on board the IC chip. Thus, if the switching regulator is to be built on the IC chip, the number terminals of the IC chip is increased, resulting in an increased number of components mounted outside the chip.

If the soft start function is to be implemented by the counter or the D/A converter, as in Patent Document 2, the circuit is increased in size in an amount corresponding to the size of the counter and the D/A converter.

Further, if the duty ratio of switch on/off is fixed during the soft start time, as in Patent Document 3, the value of the rush current is influenced by the coil inductance, even granting that the circuit may then be made smaller in size. As a result, a larger rush current will flow depending on the value of the coil inductance. On the other hand, if, in changing the duty ratio to adjust the soft start time, the duty ratio is changed in an increasing direction, the on-time of the transistor Q1, as a switch, is protracted, resulting in the current flow of a large rush current.

In one aspect of the present invention, there is provided a switching regulator comprising a switch circuit that delivers power from a power supply source to an output side, a smoothing circuit that smoothes the voltage at the output side, an on/off control circuit that changes a duty ratio to control on/off of the switch circuit, depending on the magnitude of an output voltage, so that an output voltage will be equal to a preset voltage, and an on-resistance control circuit that exercises control to increase an on-resistance of the switch circuit when the output voltage is lower by not less than a predetermined voltage than the preset voltage.

The meritorious effects of the present invention are summarized as follows.

According to the present invention, the on-resistance of the switch circuit is controlled to be larger for a lower output voltage. It is thus possible to obtain a switching regulator of a smaller circuit size without increasing the number of components.

### BRIEF DESCRIPTION OF THE DRAWINGS

FIG. 1 is a global block diagram of a switching regulator according to Example 1 of the present invention.

FIG. 2 is a block diagram showing an on-resistance control circuit, with its peripheral circuits, in the switching regulator of Example 1.

FIG. 3 is a waveform diagram at the start time of operation of the switching regulator of Example 1.

FIG. 4 is a block diagram showing an on-resistance control circuit, with its peripheral circuits, in a switching regulator of Example 2 of the present invention.

FIG. 5 is a block diagram showing an on-resistance control circuit, with its peripheral circuits, in a switching regulator of Example 3 of the present invention.

FIG. 6 is a block diagram showing a basic constitution of a switching regulator.

FIG. 7A is a block diagram of a conventional switching regulator shown in Patent Document 1.

FIG. 7B is a waveform diagram of the conventional switching regulator shown in FIG. 7A.

FIG. 8A is a block diagram of a conventional switching regulator shown in Patent Document 2.

FIG. 8B is a waveform diagram of the conventional switching regulator shown in FIG. 8A.

FIG. 9A is a block diagram of a conventional switching regulator shown in Patent Document 3.

FIG. 9B is a waveform diagram of the conventional switching regulator shown in FIG. 9A.

### PREFERRED MODES

First, the schematics of exemplary embodiments of the present invention will be described. It should be observed that the drawings and reference numerals used therein are given only by way of illustration of the exemplary embodiments and are not intended to limit variations of the exemplary embodiments of the present

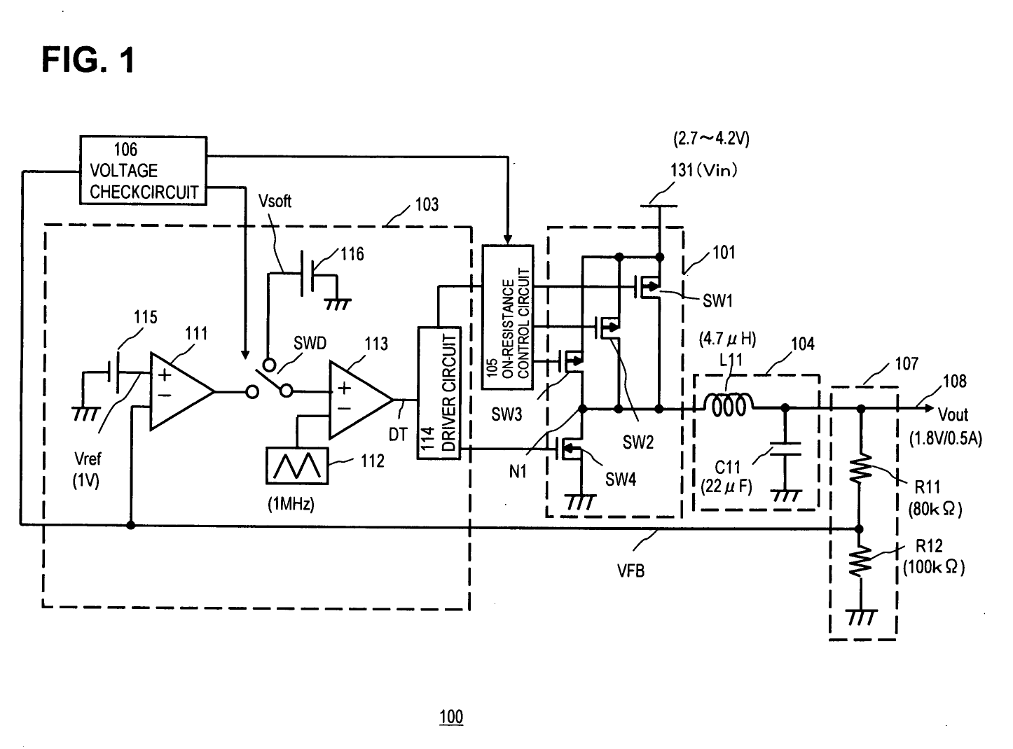

A switching regulator 100 according to an exemplary embodiment of the present invention is shown by way of an example in FIG. 1. The switching regulator includes a switch circuit 101 that delivers power from a power supply 131 to an output side (to a voltage output terminal 108), and a smoothing circuit 104 that smoothes a voltage Vout on an output side. The switching regulator also includes an on/off control circuit 103 that changes the duty ratio depending on the value of the output voltage Vout to control the on/off of the switch circuit 101 in order to provide the output voltage Vout equal to a preset voltage. The switching regulator further includes an on-resistance control circuit 105 that exercises control to increase the on-resistance of the switch circuit when the output voltage Vout is lower by not less than a predetermined value than the preset voltage. That is, since the on-resistance of the switch circuit 101 is increased when the output voltage Vout is low, it is possible to suppress a large rush current from flowing at the start time when the output voltage is as yet low.

The on/off control circuit 103 may set the duty ratio at a fixed value at least when the on-resistance control circuit 105 exercises control to increase the on-resistance. By the on/off control circuit 103 setting the duty ratio at the fixed value, it becomes possible to elevate the output voltage at a constant rate as the rush current is suppressed.

There is further provided a voltage check circuit 106 that inputs a voltage VFB, proportionate to the output voltage Vout, to determine its voltage level. Based on the result of voltage check by the voltage check circuit 106, it is possible for the on-resistance control circuit 105 to control the on-resistance and for the on/off control circuit 103 to control whether or not the duty ratio is to be fixed. The on/off control circuit 103 includes an error amplifier 111 that inputs the voltage VFB proportionate to the output voltage Vout and a reference voltage Vref to output an error voltage. The on/off control circuit 103 further includes a triangular wave generator 112 that generates and outputs a triangular wave, and a voltage comparator circuit 113 that inputs the error voltage and the triangular wave to output an on/off timing signal. Moreover, in the on/off control circuit 103, when the output voltage Vout is lower by not less than a predetermined value than the preset voltage, a fixed voltage Vsoft is delivered, in place of the error voltage, viz., an output of the error amplifier 111, to the voltage comparator circuit 113 to provide for a fixed value of the duty ratio. The switching regulator 100 further includes a voltage divider circuit 107 for dividing the output voltage Vout. The voltage divided by the voltage divider circuit 107 is delivered to the voltage check circuit 106 and to the error amplifier 111 provided in the on/off control circuit 103.

The on/off control circuit 103 exercises control so that, when the output voltage Vout is not less than a first voltage, the duty ratio will be changed so that the output voltage Vout will be equal to the preset voltage. When the output voltage Vout is lower than the first voltage, the duty ratio is fixed. The on-resistance control circuit 105 exercises control so that, when the output voltage Vout is lower than a second voltage which is lower than the first voltage, the on-resistance will be increased. The on-resistance control circuit 105 also exercises control so that, when the output voltage Vout is lower than the second voltage, the resistance value increased with decreasing the voltage value. It is observed that, in determining the large/small relationship between the output voltage Vout and the first or second voltage, the output voltage Vout may directly be compared to the first or second voltage. Or, the output voltage Vout may be divided by the voltage divider circuit 107, as in Example 1 shown in FIG. 1, to yield a voltage VFB, which may then be compared to reference voltages (Vr1, Vr2) as in Example of FIG. 1.

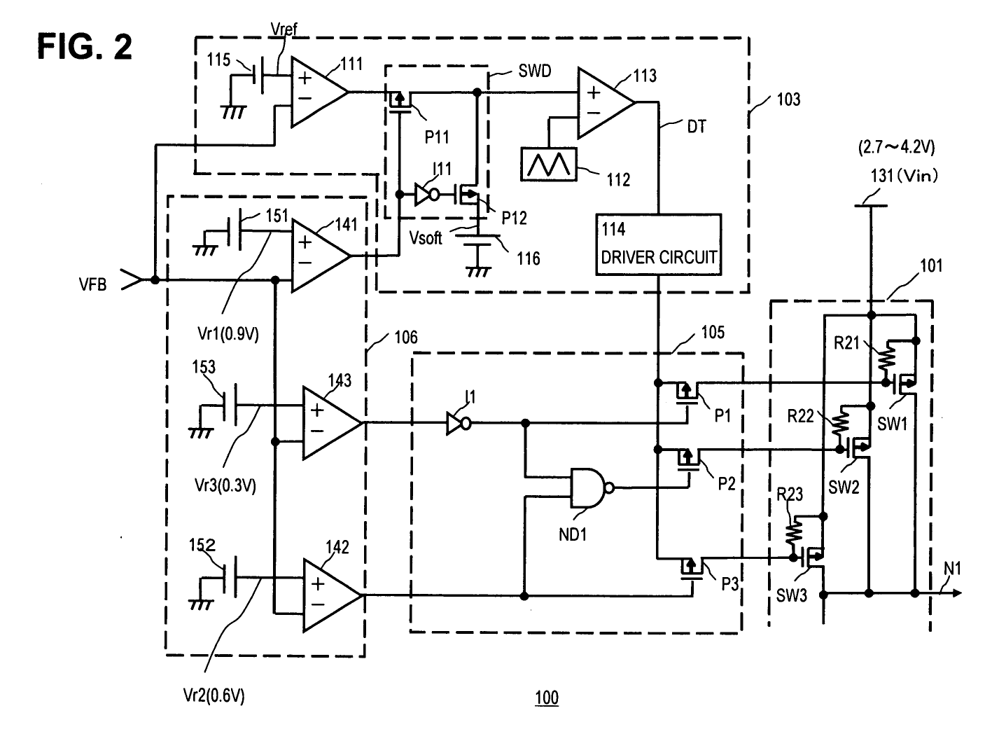

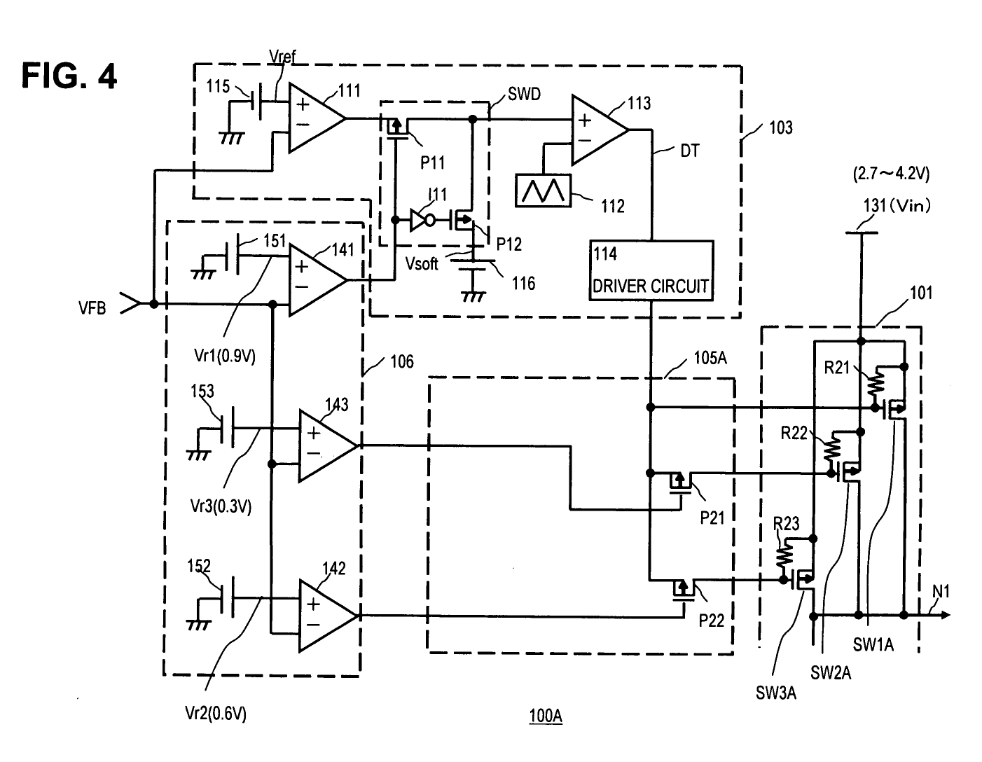

In an Example shown in FIG. 2, the switch circuit 101 includes a plurality of switch elements SW1 to SW3 connected in parallel with one another. In another Example, shown in FIG. 4, the switch circuit 101 includes a plurality of switch elements SW1A to SW3A connected parallel to one another. The on-resistance control circuit 105 in FIG. 2 controls the on-resistance of the switch circuit by switching among the switch elements SW1 to SW3. Specifically, the on-resistance control circuit switches between the switch element that exercises on/off control based on an on/off control signal output from the on/off control circuit 103 and the switch elements that keep off-state without on/off control. An on-resistance control circuit 105A in FIG. 4 exercises control for the switch elements SW1A to SW3A in a manner similar to that of the on-resistance control circuit 105 in FIG. 2 described above.

In the Example shown in FIG. 2, the on-resistances of the switch elements SW1 to SW3, connected in parallel with one another, are of respective different values. The on-resistance control circuit 105 selects an optional one or ones of the switch elements SW1 to SW3, connected in parallel with one another, depending on the value of the output voltage Vout, such as to exercise the above mentioned on/off control.

In the Example shown in FIG. 4, on-resistance control circuit 105A changes the number of the parallel-connected switch elements, controlled on or off simultaneously, out of the parallel-connected switch elements SW1A to SW3A, depending on the value of the output voltage.

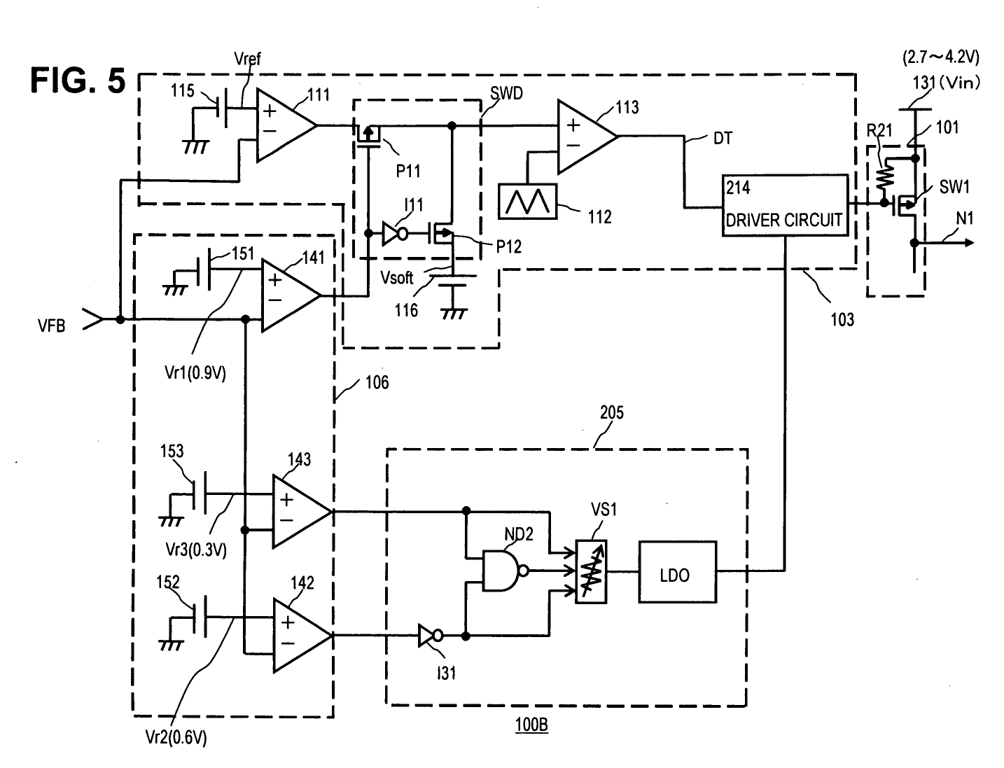

In an Example shown in FIG. 5, the switch circuit 101 includes a switching transistor SW1. Depending on the value of the output voltage Vout, an on-resistance control circuit 205 controls the bias voltage of the switching transistor SW1 that allows the transistor to be turned on, thereby controlling the on-resistance of the switching transistor SW1. The on/off control circuit 103 includes a driver circuit 214 for driving the switch circuit 101. The on-resistance control circuit 205 includes a power supply circuit for the driver circuit 214, and controls the power supply voltage delivered to the driver circuit 214 to control the on-resistance of the switch circuit 101.

With the exception of the smoothing circuit 104, the above mentioned circuits are integrated on a one-chip semiconductor substrate. Stated differently, the circuits that make up the switching regulator of FIG. 1, with the exception of the smoothing circuit 104, may be mounted with ease in a one-chip semiconductor integrated circuit.

Referring to the drawings, certain Examples of the present invention will be described in detail with reference to the drawings.

### EXAMPLE 1

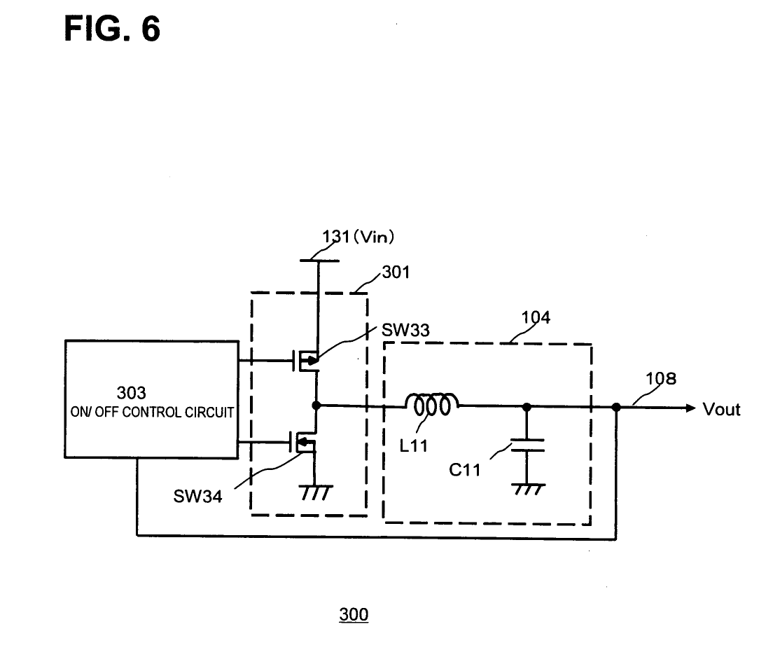

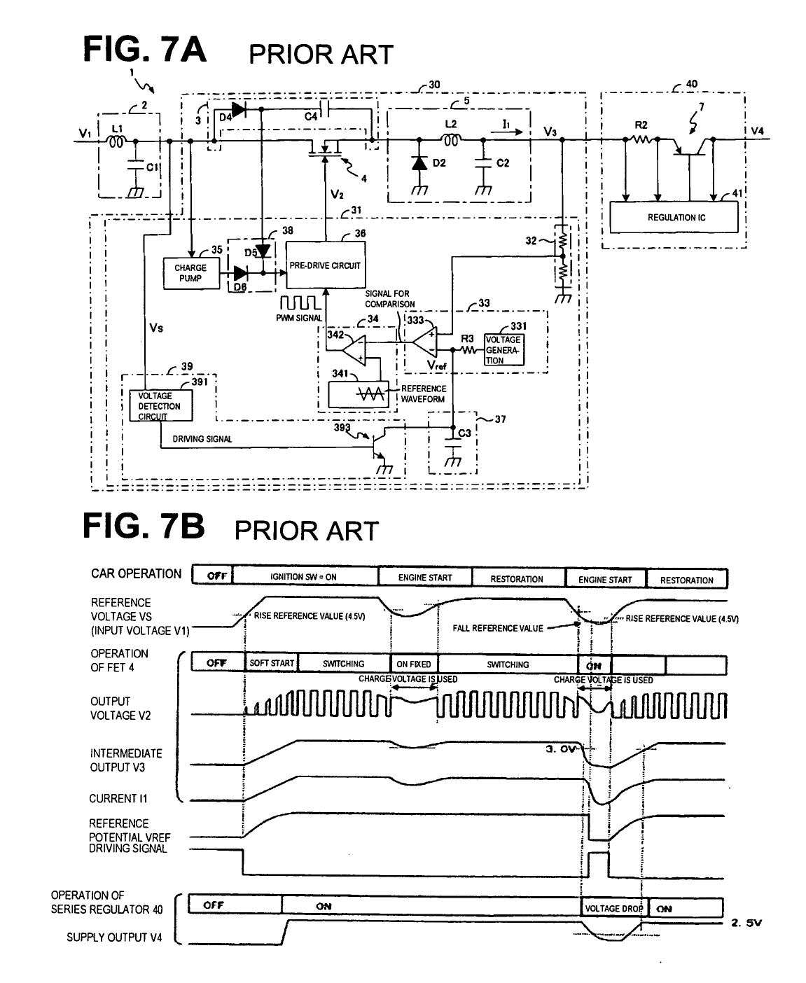

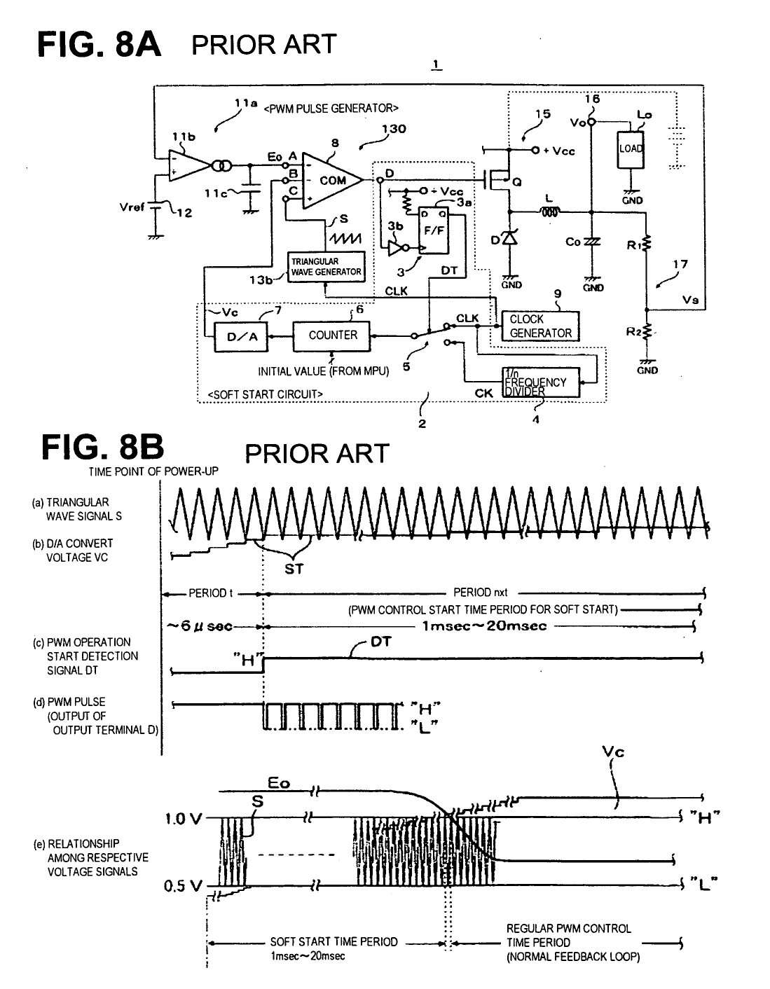

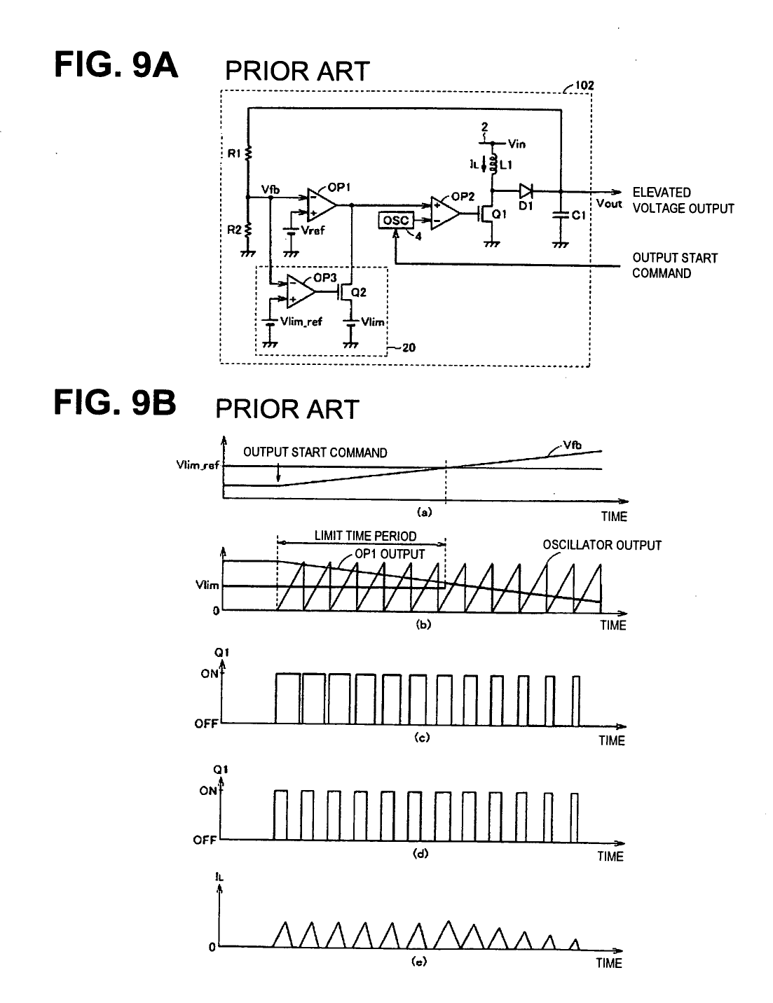

FIG. 6 depicts a block diagram showing a fundamental configuration of a switching regulator 300. Initially, by referring to FIG. 6, the fundamental configuration and operation of the switching regulator will be described. The switching regulator 300 of FIG. 6 transforms the power supply voltage of a dc power supply 131 on an input side into a dc output voltage Vout, lower than an input side power supply voltage Vin, to deliver the dc output voltage as an output. The switching regulator 300 includes a switch circuit 301, an on/off control circuit 303, and a smoothing circuit 104. The switch circuit 301 includes switches SW33 and SW34 and the on/off control circuit 303 controls the on/off of the switches SW33 and SW34. The smoothing circuit 104 smoothes the output voltage of the switch circuit 301. The smoothing circuit 104 includes a coil L11, connected between an output terminal of the switch circuit 301 and a voltage output terminal 108 for the entire switching regulator 300, and a capacitor C11 connected between the voltage output terminal 108 and the ground.

The switching regulator 300 turns the switches SW33, SW34 on or off, by way of performing a changeover operation, thereby transforming the input voltage Vin into the output voltage Vout. With a switching period t and an on-time ton of the switch SW33, a duty ratio D=ton/t and Vout=D×Vin. In the switching regulator, the output voltage is not to be varied even if the input power supply voltage Vin or the load current lout is varied. To this end, the on/off circuit 303 is feedback-controlled by the output voltage Vout, and changes the duty ratio D to generate the constant output voltage Vout.

FIG. 1 depicts a block diagram showing a global configuration of the switching regulator 100 of Example 1. Initially, the configuration of the switching regulator 100 is explained. Meanwhile, the components which are approximately the same in constitution and operation as those of FIG. 6 are denoted by the same reference numerals, and the description therefore is dispensed with. The switching regulator 100, shown in FIG. 1, includes a switch circuit 101, and an on/off control circuit 103 that controls the on/off of the switch circuit 101. The switching regulator also includes a smoothing circuit 104 that smoothes the output voltage of the switch circuit 101, and a voltage divider circuit 107 that divides the output voltage Vout, which has been smoothed by the smoothing circuit 104 and output at a voltage output terminal 108. The switching regulator also includes a voltage check circuit 106 that determines the voltage VFB divided by the voltage divider circuit 107. The switching regulator further includes an on-resistance control circuit 105 that controls the on-resistance of the switches SW1 to SW3, contained in the switch circuit 101, based on the result of voltage determination by the voltage check circuit 106.

The switch circuit 101 includes switches SW1 to SW3, connected in parallel between the power supply 131 and an output node N1, and a switch SW4, connected between the ground and the output node N1. It is observed that the switches SW1 to SW3 are formed by PMOS transistors, and the switch SW4 is formed by an NMOS transistor.

The smoothing circuit 104 includes a coil L11 and a capacitor C11, and operates to smooth a voltage output by the switch circuit 101 to deliver the output voltage Vout at the voltage output terminal 108. It is observed that, during use of the switching regulator 100, a constant dc voltage Vout may be supplied from the voltage output terminal 108 to an electronic circuit, not shown. The voltage divider circuit 107 includes resistors R11, R12, connected in series between the voltage output terminal 108 and the ground, and generates a feedback voltage VFB obtained on division of the output voltage of the voltage output terminal 108 by resistance values of the resistors R11, R12. The feedback voltage VFB is supplied to the on/off control circuit 103 and to the voltage check circuit 106 for use in exercising control based on the voltage value of the output voltage (Vout).

The voltage check circuit 106 determines the voltage level of the feedback voltage VFB to deliver a control signal, which is based on the determined results, to the on/off control circuit 103 and to the on-resistance control circuit 105.

The on/off control circuit 103 includes a reference power supply 115, outputting the reference voltage Vref that acts as a reference for the output voltage Vout, and an error amplifier 111. The error amplifier amplifies an error voltage between the feedback voltage VFB and the reference voltage Vref. The feedback voltage VFB and the reference voltage Vref are coupled to an inverting input terminal and a non-inverting input terminal of the error amplifier 111, respectively. The output voltage of the error amplifier 111 is increased or decreased in case the feedback voltage VFB is lower or higher than the reference voltage Vref, respectively. The case where the feedback voltage VFB is equal to the reference voltage Vref thus represents a boundary or a reference.

An output signal of the error amplifier 111 is delivered to a duty ratio changeover switch SWD. The duty ratio changeover switch SWD selects, in dependence upon the control signal output from the voltage check circuit 106, the output signal of the error amplifier 111 or the soft start reference voltage Vsoft output from a reference power supply 116, and outputs the so selected signal. During the normal operation, with the output voltage Vout then being HIGH in level, the duty ratio changeover switch SWD selects an output signal of the error amplifier 111. When the output voltage Vout is LOW in level, the duty ratio changeover switch outputs the reference voltage Vsoft as a fixed voltage.

An output signal of the duty ratio changeover switch SWD is connected to a non-inverting input terminal of the voltage comparator circuit 113. A triangular waveform signal, generated by the triangular wave generator 112, is coupled to an inverting input terminal of the voltage comparator circuit 113. Meanwhile, the triangular waveform signal, generated by the triangular wave generator 112, is a steady-state triangular waveform signal of a fixed period, such as 1 MHz. The voltage comparator circuit 113 compares the voltage level of the triangular waveform signal to that of the output signal of the duty ratio changeover switch SWD. If the voltage level of the output signal of the duty ratio changeover switch SWD is higher, the voltage comparator circuit outputs a HIGH level pulse signal DT. If conversely the voltage level of the output signal of the duty ratio changeover switch SWD is lower, the voltage comparator circuit outputs a low level pulse signal DT. The pulse signal DT, output from the voltage comparator circuit 113, is to be an on/off timing signal DT that determines an on/off timing of the switch circuit 101. Since the triangular waveform signal is a steady-state signal, the duty ratio of the on/off timing signal DT is determined by the voltage level of the output signal of the duty ratio changeover switch SWD. The higher the voltage level of the output signal of the duty ratio changeover switch SWD, the larger becomes the value of the duty ratio of the on/off timing signal DT.

Based on the result of voltage check by the voltage check circuit 106, the on-resistance control circuit 105 controls the on-resistance values of the on/off controlling switches by the driver circuit 114. In Example 1, the switch element, controlled on or off based on the result of voltage determination by the voltage check circuit 106, is selected out of the parallel-connected switch elements SW1 to SW3 of respective different resistance values, as will be explained in more detail hereinbelow. The non-selected switch elements are kept in off-states.

The values of constants in this switching regulator 100 of FIG. 1 will now be shown only by way of illustration. Referring to FIG. 1, the input voltage Vin ranges between 2.7V and 4.2V, the output voltage Vout is 1.8V/0.5A, the inductance of the coil L11 is 4.7 μH, the capacitance of the capacitor C11 is 22 μF, the resistances of the resistors R11, R12 are 80 kΩ and 100 kΩ, respectively, the reference voltage Vref is 1V and the frequency of the triangular wave of the triangular wave generator 112 is 1 MHz. These values of the constants are merely illustrative of desirable values of the constants and may freely be selected depending on specific design requirements.

In the switching regulator 100 of FIG. 1, the configuration of the on-resistance control circuit 105 and its peripheral internal circuits are shown in FIG. 2, in which the same components as those shown in FIG. 1 are denoted by the same reference numerals and are not here described. Referring to FIG. 2, the voltage check circuit 106 includes three reference power supplies 151 to 153 of respective different voltages and voltage comparator circuits 141 to 143. The voltage comparator circuits 141 to 143 compare the feedback voltage VFB to output voltages Vr1 to Vr3 of the reference power supplies 151 to 153. The voltages Vr1 to Vr3, output by the reference power supplies 151 to 153, respectively, are lower than the reference voltage Vref of the error amplifier 111. Of the voltages Vr1 to Vr3, Vr1 is the highest voltage, and Vr3 is the lowest voltage, with Vr2 being a voltage intermediate between Vr1 and Vr3. In the present Example, Vref is IV, whereas Vr1 is 0.9V, Vr2 is 0.6V and Vr3 is 0.3V.

The feedback voltage VFB is coupled to the inverting input terminals of the voltage comparator circuits 141 to 143, to the non-inverting terminals of which are coupled the reference voltages Vr1 to Vr3, respectively. The voltage comparator circuits 141 to 143 output high-level and low-level signals when the feedback voltage VFB is lower and higher than the respective reference voltages Vr1 to Vr3, respectively.

An output signal of the voltage comparator circuit 141 is coupled to the duty ratio changeover switch SWD. This duty ratio changeover switch SWD includes a PMOS transistor P11, an inverter I11 and another PMOS transistor P12. The PMOS transistor P11 has a source coupled to an output signal of the error amplifier 111, while having a drain connected to the non-inverting input terminal of the voltage comparator circuit 113 and having a gate coupled to an output signal of the voltage comparator circuit 141. The inverter I11 inverts the output signal of the voltage comparator circuit 141. The PMOS transistor P12 has a source coupled to the output voltage signal Vsoft of the reference power supply 116, while having a drain connected to the non-inverting input terminal of the voltage comparator circuit 113 and having a gate coupled to an output signal of the invert 111.

In the above arrangement, if the feedback voltage VFB is higher than the reference voltage Vr1 (0.9V), the output voltage of the error amplifier 111 is selected by the duty ratio changeover switch SWD so as to be delivered to the non-inverting input terminal of the voltage comparator circuit 113. Hence, the on/off timing signal DT, output by the voltage comparator circuit 113, becomes a PWM signal whose duty ratio is changed in response to an output voltage of the error amplifier 111.

If conversely the feedback voltage VFB is lower than the reference voltage Vr1 (0.9V), the reference voltage Vsoft for setting a fixed value of the duty ratio is selected by the duty ratio changeover switch SWD and is supplied to the non-inverting input terminal of the voltage comparator circuit 113. Hence, the on/off timing signal DT, output by the voltage comparator circuit 113, becomes a pulse signal with a fixed duty ratio.

Output signals of the voltage comparator circuit 142, 143 of the voltage check circuit 106 are coupled to the on-resistance control circuit 105, which on-resistance control circuit controls the on-resistance of the switch circuit based on output signals of the voltage comparator circuits 142, 143.

The on-resistance control circuit 105 includes PMOS transistors P1 to P3 whose sources are coupled to an output signal of the driver circuit 114 and whose respective drains are connected to the respective gates of the switches SW1 to SW3. An output signal of the voltage comparator circuit 143 is inverted by an inverter I1 so as to be coupled to the gate of the PMOS transistor P1. An output signal of the inverter I1 is also coupled to a first input terminal of a NAND circuit ND1. An output signal of the voltage comparator circuit 142 is coupled to a second input terminal of the NAND circuit ND1, whose output signal is coupled to the gate of the PMOS transistor P2. The output signal of the voltage comparator circuit 142 is also coupled to the gate of the PMOS transistor P3.

There are provided pull-up resistors R21 to R23 between the gates and the sources of the switches SW1 to SW3 of the switch circuit 101, respectively. These switches are formed by PMOS transistors. The pull-up resistors turn the switches off when the impedances at the gates are HIGH in level.

In the above arrangement, when the feedback voltage VFB is equal to Vr3 (0.3V) or less, the output signals of the voltage comparator circuits 142, 143 are HIGH in level. The PMOS transistor P1 is thus turned on, while the PMOS transistors P2, P3 are both turned off. The switch SW1 thus performs a switching operation by an on/off control signal output from the driver circuit 114, while the switches SW2, SW3 are kept in off-states.

When the feedback voltage VFB is at a voltage level intermediate between Vr2 (0.6V) and Vr3 (0.3V), the output signals of the voltage comparator circuits 142, 143 are at HIGH and LOW levels, respectively. The PMOS transistor P2 is turned on, while the PMOS transistors P1, P3 are both turned off. Hence, by the on/off control signal, output from the driver circuit 114, the switch SW2 performs a switching operation. The switches SW1, SW3 are kept in off-states.

In similar manner, if the feedback voltage VFB is not less than Vr2 (0.6V), the output signals of the voltage comparator circuits 142, 143 are both at LOW levels, so that the PMOS transistor P3 is turned on, while the PMOS transistors P1, P2 are both turned off. Hence, the switch SW3 performs a switching operation by the on/off control signal output from the driver circuit 114. The switches SW1, SW2 are kept in off-states.

Thus, depending on the feedback voltage VFB, viz., the output voltage of the switching regulator 100, one of the three switches SW1 to SW3, connected in parallel with each other, is selected to perform an on/off operation. The non-selected two switches are kept in off-states. Hence, by setting the values of the on-resistances of the switches SW1 to SW3 so that SW1>SW2>SW3, the value of the on-resistance of the switch circuit may be increased in soft start to prevent the rush current from flowing. The value of the on-resistance of the switch circuit 101 may be decreased stepwise as the output voltage Vout rises. When the feedback voltage VFB has exceeded Vr2 (0.6V), the on-resistance value of the switch circuit may be set to a resistance value of the normal operating state.

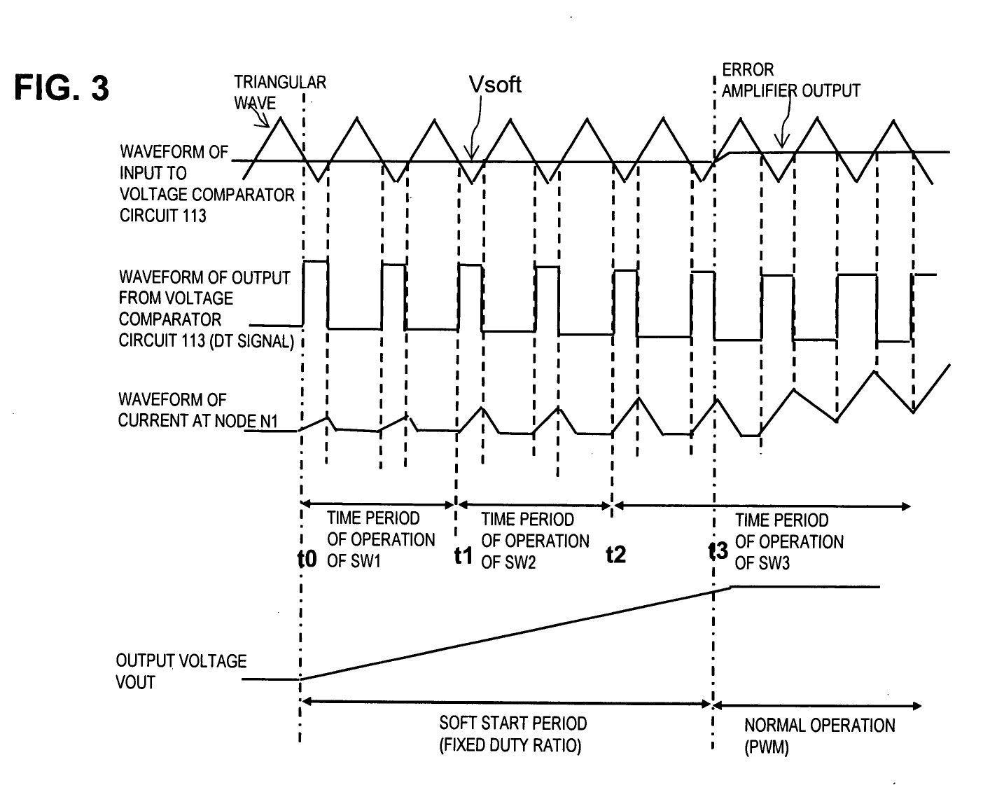

The operation of the switching regulator 100 of Example 1 will now be described with reference to the timing diagram of FIG. 3. It is assumed that, at a timing before timing t0 in the timing diagram of FIG. 3, none of the switches of the switching regulator 100 has started its operation, with the output voltage being at a low voltage level. When the operation starts at timing t0, the output voltage Vout is approximately 0V, and hence the feedback voltage VFB, divided from the voltage Vout, is also approximately 0V. The duty ratio changeover switch SWD, shown in FIGS. 1 and 2, thus selects the reference voltage Vsoft configured for setting a fixed value of the duty ratio. Hence, the on/off timing signal DT, output from the voltage comparator circuit 113, represents a pulse signal of the fixed duty ratio.

When the pulse of the fixed duty ratio is selected, the switch SW4, provided between the output node N1 and the ground, in FIG. 1, is kept in an off-state. Hence, the circuit represents an opened loop, with the output voltage Vout rising at a certain gradient corresponding to the fixed duty ratio (soft start). On the other hand, the on-resistance control circuit 105 selects the switch SW1 of the highest on-resistance value out of the switches SW1 to SW3. As a result, the rush current may be suppressed to a lower value.

Next, at a timing t1, the feedback voltage VFB exceeds Vr3 (0.3V) with rise in the output voltage Vout. The on-resistance control circuit 105 changes over from one switch to another, among the on/off controlling switches SW1 to SW3, specifically, from the switch SW1 to the switch SW2 having a smaller on-resistance.

At a timing t2, the feedback voltage VFB exceeds Vr2 (0.6V) with rise in the output voltage Vout. The on-resistance control circuit 105 changes over to another on/off controlling switch, among the on/off controlling switches, specifically, to the switch SW3 having a further smaller on-resistance.

At a timing t3, the feedback voltage VFB exceeds Vr1 (0.9V) as the output voltage Vout rises. The duty ratio changeover switch SWD changes over the input voltage of the voltage comparator circuit 113 from the reference voltage Vsoft to an output voltage of the error amplifier 111. The soft start operation by the fixed duty ratio by the switch SW3 then comes to a close to switch to the normal operation by the variable duty ratio by the switches SW3 and SW4. During the normal operation, the switches SW3, SW4 are controlled to be on or off as the duty ratio is changed, depending e.g., on the size of the load, so that the output voltage Vout will converge to a target voltage.

### EXAMPLE 2

FIG. 4 depicts a block diagram showing the on-resistance control circuit 105A of a switching regulator 100A of Example 2 and its peripheral circuits. The switching regulator 100A of Example 2 slightly differs in circuit configuration and function from the switching regulator 100. Moreover, the on-resistance values of the switches SW1A to SW3.A of the switch circuit 101 differ slightly from those of the switches SW1 to SW3 of Example 1. In other respects, the present Example 2 is the same in circuit configuration as the Example 1 shown in FIGS. 1 and 2. In Example 1, one of the switches SW1 to SW3 is selected to perform the on/off operation, with the remaining switches being kept in off-states. In Example 2, the number of switches, controlled to be turned on or off in parallel, among the parallel-connected switches SW1A to SW3A, is changed depending on the result of voltage comparison as detected by the voltage comparator circuits 142, 143.

Viz., in case the feedback voltage VFB is lower than any of the reference voltages Vr2 (0.6V) or Vr3 (0.3V), the voltage comparator circuits 142, 143 both output a HIGH level. Hence, the PMOS transistors P21, P22 are both turned off. The switches SW2A, SW3A are kept in off-states, irrespectively of the logical level of the output signal of the driver circuit 114. As a result, only the switch SW1A performs an on/off operation by the output signal of the driver circuit 114.

In case the feedback voltage VFB is higher than the reference voltage Vr3 (0.3V) and lower than the reference voltage Vr2 (0.6V), the voltage comparator circuits 142, 143 output a HIGH level and a LOW level, respectively. Hence, the PMOS transistor P21 is turned on, with the PMOS transistor P22 being turned off. The switch SW3A is thus kept in an off-state, irrespectively of the output signal level of the driver circuit 114. However, the switches SW1A and SW2A perform on/off operations in parallel by an output signal of the driver circuit 114.

If the feedback voltage VFB is increased further to higher than any of the reference voltages Vr3 (0.3V) or Vr2 (0.6V), the voltage comparator circuits 142, 143 both output LOW levels. Hence, the PMOS transistors P21, P22 are both turned on. The switches SW1A to SW3A both perform on/off operations in parallel by the output signal of the driver circuit 114. In other respects, the present Example is approximately the same as that of Example 1.

If, with the present Example 2, the on-resistance is to be decreased, it is unnecessary to reduce the on-resistance of the single switch, thus enabling the switch layout area to be reduced. The reason is that a plurality of switches, connected in parallel with one another, are controlled to be turned on or off simultaneously. Moreover, the configuration of the on-resistance control circuit may be simpler than in Example 1. The on-resistance values of the switches SW1A to SW3A may be the same as or different from one another. In addition, in the switch circuit 101, the number of the switches, connected in parallel with one another, or the setting of voltage levels for on/off control simultaneously, may be changed as desired.

### EXAMPLE 3

FIG. 5 depicts a block diagram showing an on-resistance control circuit 205 of a switching regulator 100B of Example 3 with its peripheral circuits. In Examples 1 and 2, the resistance value is controlled by using a plurality of switches connected in parallel with one another, and by selectively on/off controlling these parallel switches. With the present Example 3, the resistance value of the switch itself, when the switch is turned on, is controlled.

In FIG. 5, the on-resistance control circuit 205 includes a driver power supply circuit LDO and an LDO reference voltage selection circuit VS 1. The driver power supply circuit LDO controls the negative power supply voltage (ground side power supply voltage) of a driver circuit 214. To the LDO reference voltage selection circuit VS1, there are coupled, as input signals, an output signal of a voltage comparator circuit 143, a signal corresponding to an output signal of a voltage comparator circuit 142, inverted by an inverter 131, and an output signal of a NAND circuit ND2. An output signal of the voltage comparator circuit 143 and an output signal of the inverter 131 are coupled as input signals to the gates of the NAND circuit ND2. The LDO reference voltage selection circuit VS1 controls the reference voltage, supplied to the driver power supply circuit LDO, based on the logical level of the three input signals. The driver power supply circuit LDO controls the negative power supply voltage of the driver circuit 214 based on the voltage delivered from the LDO reference voltage selection circuit VS1. An output signal of the driver circuit 214 is coupled to the gate of the PMOS transistor which is to be the switching transistor (switch) SW1 of the switch circuit 101. Hence, the on-resistance control circuit 205 controls the gate-source bias voltage of the switching transistor (switch SW1) that allows the transistor to be turned on. It is observed that a pull-up resistor R21 is connected between the gate and the source of the PMOS transistor (SW1). Otherwise, the formulation of the present Example 3 is approximately the same as that of Example 1. Hence, the components of Example 3 similar to those of Example 1 are denoted by the same reference numerals, and detailed description therefore is dispensed with.

In the above mentioned arrangement, if the feedback voltage VFB is lower than any of the reference voltages Vr3 (0.3V) or Vr2 (0.6V), the on-resistance control circuit 205 delivers a voltage which is highest as the negative power supply voltage of the driver circuit 214. Thus, when the switch SW1 formed by a PMOS transistor is turned on, the gate voltage is at a voltage just lower than the power supply voltage. As a result, the on-resistance of the switch SW1 increases.

When the feedback voltage VFB rises to a voltage intermediate between Vr3 (0.3V) and Vr2 (0.6V), the negative power supply voltage of the driver circuit 214, output by the on-resistance control circuit 205, is decreased to approach to the ground potential. The gate voltage that allows the switch SW1, formed by a PMOS transistor, to be turned on, also is decreased, and hence the on-resistance of the switch SW1 becomes smaller.

When the feedback voltage VFB has become higher than any of the reference voltages Vr3 (0.3V) or Vr2 (0.6V), the on-resistance control circuit 205 delivers the ground potential, as the negative power supply voltage, to the driver circuit 214. The gate voltage that allows the switch SW1, formed by a PMOS transistor, to be turned on, also becomes equal to the ground potential. Hence, the on-resistance of the switch SW1 becomes further smaller. Viz., in Example 3, the negative side (ground side) power supply voltage of the driver circuit 214 is changed over stepwise by the voltage value of the feedback voltage VFB, thereby changing over the on-resistance value of the switch SW1 stepwise. Otherwise, the operation is the same as that of Examples 1 and 2. That is, the switch SW1 operates with a fixed duty ratio when the feedback voltage VFB is Vr1 (0.9V) or lower, while operating with a variable duty ratio when the feedback voltage VFB is higher than Vr1 (0.9V).

With Example 3, described above, the value of the on-resistance of the switch circuit may be varied, even if only one switch is used, that is, without the necessity of providing a plurality of switches, such as SW1, in parallel. Moreover, when the on-resistance value is to be changed stepwise, it is unnecessary to increase the number of parallel-connected switches, unlike the case of Examples 1 and 2. Thus, if the number of stages of stepwise changes of the resistance values is to be increased, there is the possibility of relatively decreasing the area.

It should be noted that other objects, features and aspects of the present invention will become apparent in the entire disclosure and that modifications may be done without departing the gist and scope of the present invention as disclosed herein and claimed as appended herewith. Also it should be noted that any combination or selection of the disclosed and/or claimed elements, matters and/or items may fall under the modifications aforementioned.

What is claimed is:

1. A switching regulator comprising:
a switch circuit that delivers power from a power supply source to an output side;
a smoothing circuit that smoothes a voltage at said output side;
an on/off control circuit that changes a duty ratio to control on/off of said switch circuit, depending on a magnitude of an output voltage, so that an output voltage is equal to a preset voltage; and
an on-resistance control circuit that exercises control to increase an on-resistance of said switch circuit when said output voltage is lower by not less than a predetermined voltage than said preset voltage.

2. The switching regulator according to claim 1, wherein
said on/off control circuit sets said duty ratio at a fixed value at least when said on-resistance control circuit exercises control to increase the on-resistance.

3. The switching regulator according to claim 1, further comprising:
a voltage check circuit that inputs a voltage proportionate to said output voltage to determine the level of said voltage; wherein
said on-resistance control circuit controls the on-resistance based on the result of voltage determination by said voltage check circuit;
said on/off control circuit controlling whether or not said duty ratio is to be fixed.

4. The switching regulator according to claim 1, wherein
said on/off control circuit includes
an error amplifier that inputs a voltage proportionate to said output voltage and a reference voltage to output an error voltage;
a triangular wave generator that outputs a triangular wave; and
a voltage comparator circuit that inputs said error voltage and said triangular wave to output an on/off timing signal.

5. The switching regulator according to claim 4 wherein
when said output voltage is lower by not less than a predetermined voltage than said preset voltage, a fixed voltage is entered, in place of said error voltage, to said voltage comparator circuit to set said duty ratio at a fixed value.

6. The switching regulator according to claim 3, further comprising:
a voltage divider circuit for said output voltage; wherein
a voltage obtained on voltage division by said voltage divider circuit is delivered to said voltage check circuit and to an error amplifier provided in said on/off control circuit.

7. The switching regulator according to claim 1, wherein
in case said output voltage is not less than a first voltage, said on/off control circuit exercises control for changing said duty ratio so that said output voltage is equal to said preset voltage; said on/off control circuit setting said duty ratio at a fixed value in case said output voltage is lower than said first reference voltage; and wherein
in case said output voltage is further lower than a second voltage not higher than said first voltage, said on-resistance control circuit exercises control for increasing the on-resistance.

8. The switching regulator according to claim 7, wherein when said output voltage is lower than said second voltage, said on-resistance control circuit exercises control so that the resistance value is the larger the lower said output voltage.

9. The switching regulator according to claim 1, wherein
said switch circuit includes a plurality of switch elements connected in parallel with one another; and wherein
said on-resistance control circuit controls said on-resistance by switching, among said parallel-connected switches, between one or more switch elements, controlled on or off based on an on/off timing signal output from said on/off control circuit, and other one or more switch elements, not controlled on or off and kept in off-states.

10. The switching regulator according to claim 9, wherein
said switch elements, connected in parallel with one another, are of respective different on-resistances; and wherein
said on-resistance control circuit selects, out of said parallel-connected switch elements, one or more optional switch elements, depending on the value of said output voltage, to perform said on/off control.

11. The switching regulator according to claim 9, wherein
said on-resistance control circuit changes the number of those switch elements, controlled on or off simultaneously, out of said parallel-connected switch elements, depending on the value of said output voltage.

12. The switching regulator according claim 1, wherein
said switching circuit includes a switching transistor:
said on-resistance control circuit controlling the bias voltage that allows said switching transistor to be turned on, by the value of said output voltage, thereby controlling the on-resistance of said switching transistor.

13. The switching regulator according to claim 1, wherein
said on/off control circuit includes a driver circuit for said switch circuit;
said on-resistance control circuit including a power supply circuit for said driver circuit;
said on-resistance control circuit including a power supply circuit for said driver circuit; said on-resistance control circuit controlling the power supply voltage supplied to said driver circuit to control the on-resistance of said switch circuit.

14. The switching regulator according to claim 1, wherein
the circuits of said switching regulator, except said smoothing circuit, are integrated on a one-chip semiconductor substrate.

15. A switching regulator comprising:
a switch circuit that delivers power from a power supply source to an output side;
a smoothing circuit that smoothes a voltage at said output side;
an on/off control circuit that changes a duty ratio to control on/off of said switch circuit, depending on a magnitude of an output voltage, so that an output voltage is equal to a preset voltage; and
an on-resistance control circuit of said switch circuit;
wherein when the output voltage is lower than a first voltage, said on/off control circuit sets said duty ratio at a fixed value, said first voltage being lower than said preset voltage; and
wherein when the output voltage is lower than a second voltage, said on-resistance control circuit controls to increase an on-resistance of said switch circuit, said second voltage being lower than said first voltage.

16. The switching regulator according to claim 15, wherein
said switch circuit includes a plurality of switch elements connected in parallel with one another; and wherein
said on-resistance control circuit controls said on-resistance by switching, among said parallel-connected switches, between one or more switch elements, controlled on or off based on an on/off timing signal output from said on/off control circuit, and other one or more switch elements, not controlled on or off and kept in off-states.

17. The switching regulator according claim 15, wherein
said switching circuit includes a switching transistor:
said on-resistance control circuit controlling the bias voltage that allows said switching transistor to be turned on, by the value of said output voltage, thereby controlling the on-resistance of said switching transistor.
